(19) United States
(12) Patent Application Publication
(10) Pub. No.: US 2008/0165380 A1
(43) Pub. Date: Jul. 10, 2008

(54) HOST DEVICE AND METHOD OF INSTALLING PRINTER DRIVER THEREOF

(75) Inventors: Hee-jin LEE, Seoul (KR); Deok-hee Boo, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/965,817

(22) Filed: Dec. 28, 2007

(30) Foreign Application Priority Data
Jan. 5, 2007 (KR) 2007-1652

(51) Int. Cl. G06F 15/00

(52) U.S. Cl. 358/1.13; 358/1.15

(57) ABSTRACT

A host device to install a printer driver and a method thereof. The host device includes a storage unit to store option information set in previously installed printer driver, and a central processing unit to read the option information when a new printer driver is installed and setting the read option information as option information of the new printer driver. Accordingly, when installing the new printer driver, the user does not need to separately set the option information of the new printer driver, to thus enhance the convenience of a user.

### CROSS-REFERENCE TO RELATED APPLICATIONS

This application claims priority under 35 U.S.C. §119 (a) from Korean Patent Application No. 2007-1652, filed Jan. 5, 2007, the contents of which are incorporated herein by reference in its entirety.

### BACKGROUND OF THE INVENTION

1. Field of the Invention

The present general inventive concept relates to a host device and a method of installing a printer driver thereof. More particularly, the present general inventive concept relates to a host device to read and set option information of previously installed printer driver as option information of a new printer driver when the new printer driver is installed, and a printer driver installing method of the host device.

2. Description of the Related Art

A printer driver is generally provided by a printer manufacturer to be installed in a computer in order to control a printing function of a printer to print a document written with an application program of the computer using the printer.

The printer driver installed in a host device provides a user interface enabling a user to set option information needed to drive the printer and perform a printing job. Through the user interface provided from the printer driver, a user can set option information to be applied to the printing job corresponding to a desired result that the user wants.

Meanwhile, to disconnect the existing printer and install a new printer, it is required to delete the existing printer driver and install a new printer driver. When installing the new printer driver, option information can be set to default values. When the new printer driver is installed, the user needs to reset the option information to drive the printer and perform the printing job according to the desired settings of the user. As a result, every time the printer is changed, the resetting of the option information of the printer driver causes inconvenience to the user and takes a considerable time. Thus, a need exists for a host device in which the existing option information of the previously installed printer driver can be automatically set to correspond with a new printer driver reducing an amount of manual input from the user.

### SUMMARY OF THE INVENTION

The present general inventive concept provides a host device to set option information without a separate operation, by reading option information of at least one previously installed printer driver and to automatically set option information of a new printer driver corresponding to read option information of the previously installed printer driver when the new printer driver is installed, and a printer driver installing method of the host device.

Additional aspects and utilities of the present general inventive concept will be set forth in part in the description which follows and, in part, will be obvious from the description, or may be learned by practice of the general inventive concept.

The foregoing and/or other aspects and utilities of the general inventive concept may be achieved by providing a host device including a storage unit to store option information set in at least one previously installed printer driver, and a central processing unit to read the option information when a new printer driver is installed and to set the read option information as option information of the new printer driver.

The host device may further include a recording medium inserting portion to accommodate a recording medium to install the new printer driver, wherein the central processing unit reads the option information of the previously installed printer driver by executing an application program contained in the recording medium.

The host device may further include a user interface portion to provide a user interface to select one of the previously installed printer drivers, when a plurality of previously installed printer drivers are present, wherein the central processing unit reads option information of the printer driver selected through the user interface portion and sets the read option information as option information of the new printer driver.

The central processing unit may set an option item corresponding to the pre-stored option information, among option items of the new printer drivers, to the read option information, and set an option item not corresponding to the pre-stored option information to a default value.

The option information may be information of application programming interface (API) functions of the printer driver.

The foregoing and/or other aspects and utilities of the general inventive concept may also be achieved by providing a printer driver installing method of a host device including a reading option information set in previously installed printer driver and setting the read option information as option information of a new printer driver.

The reading may read the option information of the previously installed printer driver by executing an application program contained in a recording medium which is used to install the new printer driver.

The reading may further include providing, when a plurality of previously installed printer drivers are present, a user interface to select one of the previously installed printer drivers; and reading option information of the previously installed printer driver selected through the user interface.

The setting may set an option item corresponding to the pre-stored option information, among option items of the new printer drivers, to the read option information, and set an option item not corresponding to the pre-stored option information to a default value.

The option information may be information of application programming interface (API) functions of the printer driver.

The foregoing and/or other aspects and utilities of the general inventive concept may also be achieved by providing a method of setting option information with an installation of a new printer driver in a host device, the method including installing a new printer driver in a host device and determining the number of previously installed printer drivers present in the host device such that if the number of previously installed printer drivers is one, option information corresponding to the previously installed printer driver will automatically be provided as option information for the new print driver, if the number of previously installed printer drivers is greater than one, a listing of the previously installed printer drivers will be provided to a user to select therefrom, option information corresponding to the selected previously installed printer driver will be provided as option information for the new print driver, and if the number of previously installed printer drivers is less than one, option information corresponding to default values will automatically be provided as option information for the new print driver.

The foregoing and/or other aspects and utilities of the general inventive concept may also be achieved by providing a computer-readable recording medium having embodied thereon a computer program to execute a method, wherein the method includes reading option information set in a previously installed printer driver and setting the read option information as option information of a new printer driver.

### BRIEF DESCRIPTION OF THE DRAWINGS

These and/or other aspects and utilities of the present general inventive concept will become apparent and more readily appreciated from the following description of exemplary embodiments, taken in conjunction with the accompanying drawings of which:

FIG. 1 is a block diagram illustrating a host device according to an exemplary embodiment of the present general inventive concept;

FIG. 2 is a block diagram illustrating a host device according to an exemplary embodiment of the present general inventive concept;

FIG. 3A is a diagram illustrating an option information setup screen of a printer driver according to an exemplary embodiment of the present general inventive concept;

FIG. 3B is a diagram illustrating an option information setup screen of a printer driver according to an exemplary embodiment of the present general inventive concept;

FIG. 4A is a diagram illustrating an option information setup screen of a printer driver according to an exemplary embodiment of the present general inventive concept;

FIG. 4B is a diagram of an option information setup screen of a printer driver according to an exemplary embodiment of the present general inventive concept;

FIG. 5 is a flowchart illustrating a printer driver installing method of the host device according to an exemplary embodiment of the present general inventive concept; and

FIG. 6 is a flowchart illustrating a printer driver installing method of the host device according to an exemplary embodiment of the present general inventive concept.

### DETAILED DESCRIPTION OF THE PREFERRED EMBODIMENTS

Reference will now be made in detail to the present exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

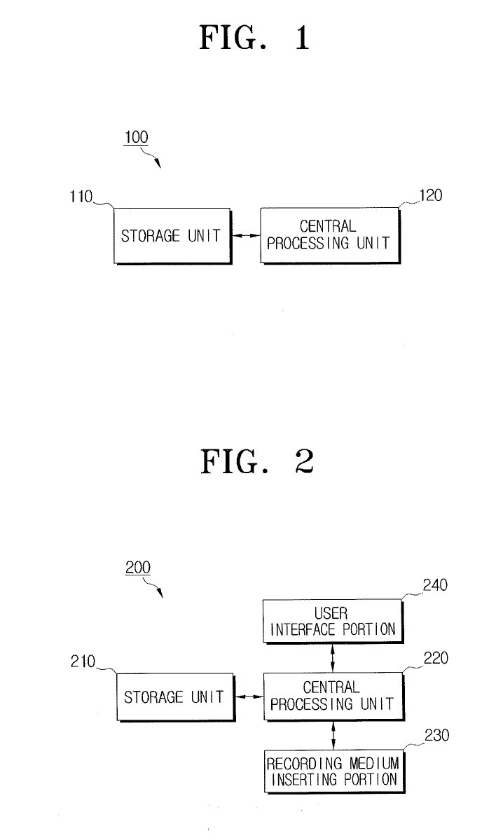

FIG. 1 is a block diagram illustrating a host device according to an exemplary embodiment of the present general inventive concept. The host device 100 of FIG. 1 includes a storage unit 110 and a central processing unit 120.

The storage unit 110 stores option information set in previously installed printer driver. The option information, which is information required to drive an installed printer and perform a printing job, can be changed according to a user's setting selection.

When a new printer driver is installed, the central processing unit 120 reads the option information of the previously installed printer driver from the storage unit 110 and sets it as option information of the new printer driver corresponding to the option information read from the preinstalled printer driver. Accordingly, when installing the new printer driver, the user does not need to reset the option information.

FIG. 2 is a block diagram of a host device according to an exemplary embodiment of the present general inventive concept. The host device 200 of FIG. 2 includes a storage unit 210, a central processing unit 220, a recording medium inserting portion 230, and a user interface portion 240.

The storage unit 210 stores option information set in the previously installed printer driver. The option information, which is information required to drive the installed printer and to perform the printing job, includes a plurality of option items. Each option item can be changed according to a user's setting selection. That is, the option information can be changed according to a user's setting selection.

The recording medium inserting portion 230 accommodates a recording medium to install the new printer driver. The recording medium can be a compact disk (CD) containing the new printer driver corresponding to the new printer. In addition to the new printer driver, the recording medium may contain a separate application program to read the option information of the previously installed printer driver.

When the new printer driver is being installed and a plurality of previously installed printer drivers are present, the user interface portion 240 provides a user interface enabling the user to select one of the previously installed printer drivers and receives a selection command from the user.

The central processing unit 220 controls an overall operation of the host device 200. Specifically, when a recording medium containing the new printer driver is inserted into the recording medium inserting portion 230, the central processing unit 220 processes to install the new printer driver by reproducing the recording medium information. The central processing unit 220 checks whether previously installed printer driver is present at the same time the new printer driver is installed. When there is the previously installed printer driver, the central processing unit 220 reads the option information of the previously installed printer driver from the storage unit 210 by executing the application program contained in the recording medium. The option information can be DEVMODE information of application programming interface (API) functions of the printer driver. DEVMODE information may contain information relating to the option items of the option information respectively.

When confirming the plurality of the previously installed printer drivers in the installation of the new printer driver, the central processing unit 220 controls the user interface portion 240 to provide the user interface enabling the user to select one of the printer drivers. The user interface can display the previously installed printer drivers as a list. The user selects one of the printer drivers displayed in the user interface so that the option information of the new printer driver can be set as the same option information of the selected printer driver.

When the selection command for one printer driver is input through the user interface portion 240, the central processing unit 220 reads the option information of the selected printer driver from the storage unit 210 by executing the application program contained in the recording medium.

When the option information of the previously installed printer driver is read from the storage unit 210 through the execution of the application program, the central processing unit 220 sets the read option information as the option information of the new printer driver. In more detail, an option item corresponding to the pre-stored option information among the plurality of the option items in the option information of the new printer driver is set by the central processing unit 220 as the option information read from the storage unit 210. In contrast, an option item not corresponding to the pre-stored option information among the option items in the option information of the new printer driver is set by the central processing unit 220 as a default value. For example, when the option item ‘dmPaper Size’ relating to the paper size is ‘dm Paper_A4 Sheet, 210×297 mm’ in the option information read from the storage unit 210, that is, in the DEVMODE information, ‘dmPaper Size’ item in the option items constituting the option information of the new printer driver can be set to ‘dmPaper_A4 Sheet, 210×297 mm’. Hence, in the option information of the new printer driver, the option item relating to the paper size can be set to A4 paper of 210(width)×297(length) mm. In the same way, the option items constituting the option information of the new printer driver can be set respectively. Consequently, when installing the new printer driver, the user does not need to reset the option information of the new printer driver to the same option information of the previously installed printer driver.

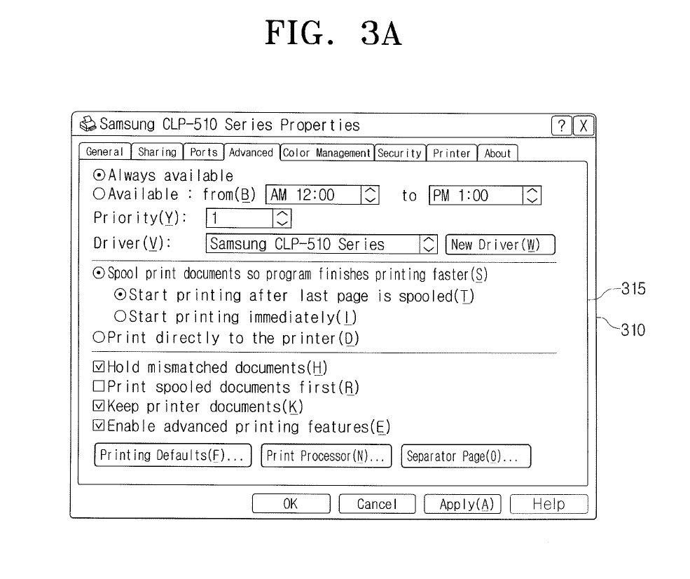

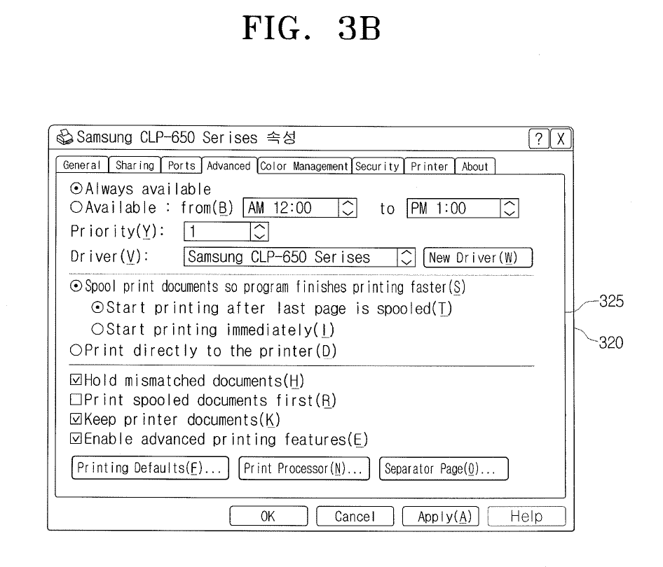

FIGS. 3A and 3B are diagrams illustrating an option information setup screen of a printer driver in relation to the printer driving according to exemplary embodiments of the present general inventive concept. FIG. 3A illustrates the option information screen 310 of the printer driver with respect to “Samsung CLP-510 Series”0 printer model. The option information screen 310 corresponds to option information relating to the printer driving and illustrates option information of ‘Advanced’ item 315 among other main items. The ‘Advanced’ item 315 can include sub-items relating to a printing available time, a printing priority, a driver (printer model), a printing start point, and other printing operations.

Referring to FIGS. 2, 3A and 3B, as the host device 200 installs the new printer driver, the option information of the previously installed printer driver, that is, the option information of the ‘Samsung CLP-510 Series’ printer driver can be read out and set to the option information of the new printer driver. Specifically, FIG. 3B illustrates an option information screen 320 of a ‘Samsung CLP-650 Series’ printer driver newly connected to the host device 200. Option information relating to ‘Advanced’ item 325 in the main items of the option information screen 320 can be set to the same as the option information of the option information screen 310 of FIG. 3A by reading the option information of the option information screen 310 in the printer driver installation of ‘Samsung CLP-650 Series’ printer model.

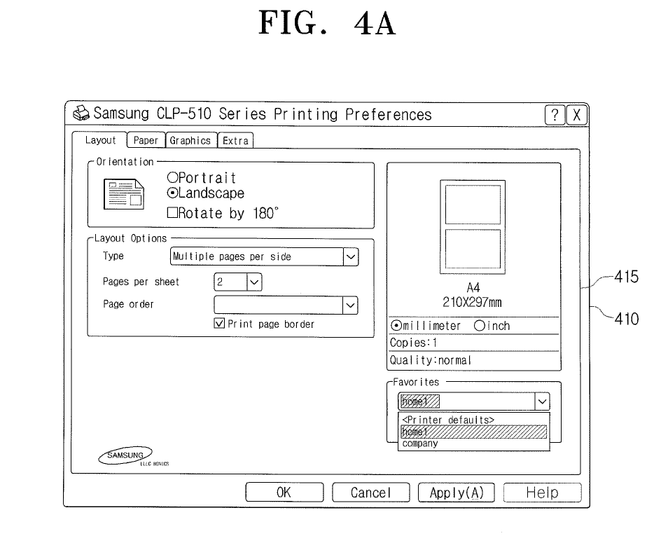

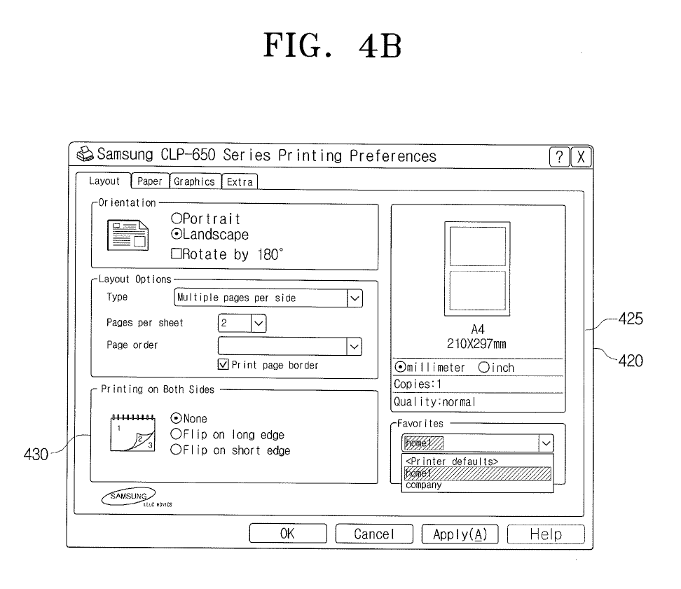

FIGS. 4A and 4B are diagrams illustrating an option information setup screen of a printer driver in relation to the printing operation according to exemplary embodiments of the present general inventive concept. FIG. 4A illustrates the option information screen 410 of ‘Samsung CLP-510 Series’ printer driver. The option information screen 410 pertains to option information of the printing operation and illustrates option information of ‘Layout’ item 415 of other main items. ‘Layout’ item 415 can include sub-items such as paper orientation, layout options, and paper size.

Referring to FIGS. 2, 4A and 4B, as the host device 200 executes the new printer driver, the option information of the previously installed printer driver, that is, the option information of ‘Samsung CLP-510 Series’ printer driver can be read and set to option information of the new printer driver. More specifically, FIG. 4B illustrates an option information screen 410 of‘Samsung CLP-650 Series’ printer driver newly connected to the host device 200. Option information in a ‘Layout’ item 425 of the main items of the option information screen 420 may be the same as the option information of the option information screen 410 of FIG. 4A by reading the option information of the option information screen 410 in the printer driver installation of ‘Samsung CLP-650 Series’ printer model.

The option information screen 420 of FIG. 4B further includes ‘Printing on Both Sides’ item 430 which is not included in the ‘Layout’ item 425 of the option information screen 410 of FIG. 4A. Of the option items of the new printer driver, the option item not corresponding to the option information of the previously installed printer driver can be set to a default value. Accordingly, the ‘Printing on Both Sides’ item 430 in the option information screen 420 can be set to the default value ‘None’.

While the option information screens of FIGS. 3A, 3B, 4A, and 4B merely relate to the specific item, the option information of the other main items can be set in the same manner. By automatically setting the option information of the previously installed printer driver as the option information of the new printer driver, the use does not need to set the plurality of the option items in the option information one by one, thus enhancing convenience of a user.

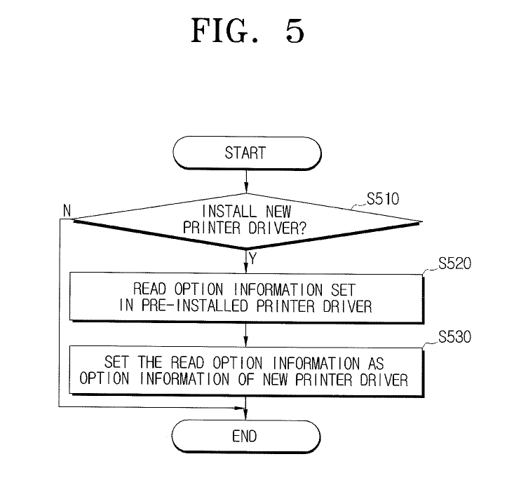

FIG. 5 is a flowchart illustrating a printer driver installing method of the host device according to an exemplary embodiment of the present general inventive concept. Referring to FIG. 5, when installing the new printer driver (operation S510), the host device 100 reads the option information set in the previously installed printer driver (operation S520).

The host device 100 sets the read option information as option information of the new printer driver (operation S530). Thus, the option information can be automatically set without having to reset the option information for every new printer driver installation.

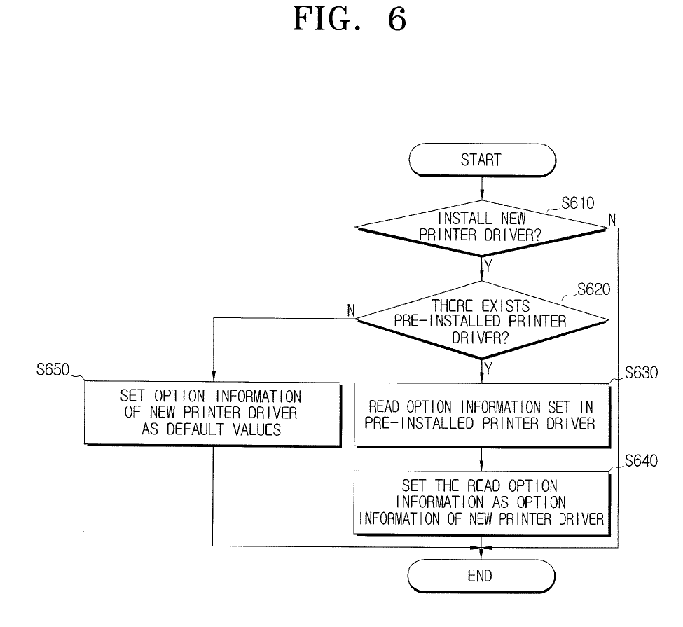

FIG. 6 is a flowchart illustrating a printer driver installing method of the host device according to another exemplary embodiment of the present general inventive concept. In FIG. 6, when installing a new printer driver (operation S610), the host device 200 checks whether previously installed printer driver is present (operation S620). The new printer driver can be installed by reproducing a recording medium, such as a CD, containing the new printer driver. When there is a plurality of previously installed printer drivers, one of the previously installed printer drivers is selected through the user interface.

When the previously installed printer driver is present, the host device 200 installs the new printer driver and simultaneously reads the option information of the previously installed printer driver by executing the application program contained in the recording medium (S630). The read option information can be DEVMODE information of API functions of the printer driver, and the DEVMODE information can include information relating to a plurality of option items constituting the option information.

Next, the host device 200 sets the read option information as option information of the new printer driver (operation S640). In more detail, among the plurality of option items in the option information of the new printer driver, the option item corresponding to the pre-stored option information is set and stored as the read option information. By contrast, among the option items in the option information of the new printer driver, the option item not corresponding to the pre-stored option information is set and stored as a default value.

When there is no previously installed printer driver (operation S620), the host device 200 installs the new printer driver by setting the option information to default values (operation S650). Therefore, if there is the previously installed printer driver, the option information of the previously installed driver is set to the option information of the new printer driver without requiring additional input from the user in the option information setup.

As set forth above, when installing the new printer driver, the option information of the previously installed printer driver is read out and automatically set as the option information of the new printer driver. Therefore, the user does not need to separately set the option information of the new printer driver, to thus enhance the convenience of the user. In addition, it is possible to reduce the unnecessary time taken to manually set the option information.

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although various exemplary embodiments of the present general inventive concept have been illustrated and described, it would be appreciated by those skilled in the art that changes may be made in this exemplary embodiment without departing from the principles and spirit of the general inventive concept, the scope of which is defined in the claims and their equivalents.

What is claimed is:

1. A host device, comprising:
a storage unit to store option information set in at least one previously installed printer driver; and
a central processing unit to read the option information when a new printer driver is installed and to set the read option information as option information of the new printer driver.

2. The host device of claim 1, further comprising:
a recording medium inserting portion to accommodate a recording medium to install the new printer driver,
wherein the central processing unit reads the option information of the previously installed printer driver by executing an application program contained in the recording medium.

3. The host device of claim 1, further comprising:
a user interface portion to provide a user interface to select one of the previously installed printer drivers, when a plurality of previously installed printer drivers are present,
wherein the central processing unit reads option information of the printer driver selected through the user interface portion and sets the read option information as option information of the new printer driver.

4. The host device of claim 1, wherein the central processing unit sets an option item corresponding to the pre-stored option information, among option items of the new printer drivers, to the read option information, and sets an option item not corresponding to the pre-stored option information to a default value.

5. The host device of claim 1, wherein the option information comprises:
information of application programming interface (API) functions of the printer driver.

6. A printer driver installing method of a host device, the method comprising:
reading option information set in at least one previously installed printer driver; and
setting the read option information as option information of a new printer driver.

7. The printer driver installing method of claim 6, wherein the reading reads the option information of the previously installed printer driver by executing an application program contained in a recording medium which is used to install the new printer driver.

8. The printer driver installing method of claim 6, wherein the reading further comprises:
providing, when a plurality of previously installed printer drivers are present, a user interface to select one of the previously installed printer drivers; and
reading option information of the previously installed printer driver selected through the user interface.

9. The printer driver installing method of claim 6, wherein the setting sets an option item corresponding to the pre-stored option information, among option items of the new printer drivers, to the read option information, and sets an option item not corresponding to the pre-stored option information to a default value.

10. The printer driver installing method of claim 6, wherein the option information comprises:
information of application programming interface (API) functions of the printer driver.
